(19) United States
(12) Patent Application Publication
(10) Pub. No.: US 2026/0163243 A1
(43) Pub. Date: Jun. 11, 2026

(54) GLAZING UNIT AND ASSOCIATED DECOATING METHOD

(71) Applicant: AGC GLASS EUROPE, Louvain-la-Neuve (BE)

(72) Inventors: Adrien LEMOINE, Gosselies (BE); Xavier RADU, Gosselies (BE); Mohsen YOUSEFBEIKI, Gosselies (BE)

(73) Assignee: AGC GLASS EUROPE, Louvain-la-Neuve (BE)

(21) Appl. No.: 19/129,163

(22) PCT Filed: Dec. 1, 2023
(86) PCT No.: PCT/EP2023/083951

§ 371 Date: May 12, 2025

(30) Foreign Application Priority Data
Dec. 14, 2022 (EP) 22213602

(51) Int. Cl. H01Q 15/00; E06B 9/24

(52) U.S. Cl. CPC H01Q 15/0006; E06B 9/24; E06B 2009/2417

(57) ABSTRACT

A glazing unit made of a glazing panel with a glass sheet which is low in reflectance for RF radiation, a coating system which is high in reflectance for RF radiation disposed on the glass sheet, at least one frequency selective decoated grid portion on the coating system; where the at least one frequency selective decoated portion has a first decoated grid and a second decoated grid; each of the first decoated grid and the second decoated grid has decoated regions in the form of grid lines arranged in a mesh-like manner; the first decoated grid being connected to the second decoated grid at a connection area. At least at the connection area, the first decoated grid has a rake design with at least a missing tooth, the second decoated grid has a rake design.

### TECHNICAL FIELD

The present invention relates to a glazing unit comprising a glass sheet which is low in reflectance for RF radiation and a coating system which is high in reflectance for RF radiation disposed on the said glass sheet, in general and, more specifically, to an enhanced glazing unit comprising at least a frequency selective decoated portion on the coating system.

Thus, the invention concerns multiple domains where a glazing unit is used such a mounted on a stationary object, for instance a building, or mounted on a mobile object, for instance a vehicle, a train.

### BACKGROUND ART

In recent years, it is a common practice to reduce electric-power consumption, for example, by moderately using air conditioners or the like for cooling, in order to prevent the global warming. An attempt is being made accordingly to impart the function of a coating system, such as reflecting infrared rays (heat rays), to the glazing unit of vehicles, buildings, etc. to thereby reduce the intake of heat from sunlight to the inside of the vehicles or buildings.

Such coating systems, however, are typically electrically conductive and are high in reflectance for RF radiation. This makes the coating systems efficient reflectors of broad bands of radio frequency signals. Furthermore, commercial construction, automotive, train, . . . tend to use other materials that further block RF signals. Materials such as concrete, brick, mortar, steel, aluminium, roofing tar, gypsum wall board, and some types of wood all offer varying degrees of RF absorption. The result is that many newer constructions severely impede RF signals from getting into or out of the buildings. This effect impedes reception or transmission by antennas and/or terminals.

As a method of providing the window or the like with a heat ray reflection function, for example, a method of forming a thin film containing a metal having a heat ray reflection function such as silver (heat ray reflection film) on a glass sheet or the like can be cited.

When a substrate having a heat ray reflection function is applied to, for example, a window glass, high transparency to radio waves of a predetermined frequency is also required but a coating system is high in reflectance for RF radiation.

Nonetheless, RF devices have become an important part of modern life, especially with the huge penetration of cellular smartphones, tablets, IoT (Internet of Things) devices, that are requiring a deep penetration in the buildings or automotive of electromagnetic field for indoor coverage, even at high spectrum frequencies up to 110 GHz. Such devices may include cellular transceivers, wireless local area network (“Wi-Fi”) transceivers, Global Positioning System (GPS) receivers, Bluetooth transceivers and, in some cases, other RF receivers (e.g., FM/AM radio, UHF, etc.). As the popularity of such devices has grown, the importance of being able to use RF-based features within the confines of modern commercial buildings has grown.

In addition, in order to increase the speed and capacity of wireless communication, frequency bands to be used are becoming higher, like the frequency bands for the 5th generation mobile communication system (5G). Therefore, even if a high-frequency electromagnetic wave having a broadband frequency band is used for a mobile communication, etc., it is necessary to have a wide band frequency selective surface in order to ensure the transmission of waves with different frequencies through the glazing unit.

The ITU IMT-2020 specification demands speeds up to 20 Gbps, achievable with wide channel bandwidths and massive MIMO 3rd Generation Partnership Project (3GPP) is going to submit 5G NR (New Radio) as its 5G communication standard proposal. 5G NR can include lower frequencies, below 6 GHz, and mmWave, above 15 GHz. However, the speeds and latency in early deployments, using 5G NR software on 4G hardware (non-standalone), are only slightly better than new 4G systems, estimated at 15% to 50% better. On top of that, IoT will requires indoor coverage as better as possible not for massive MTC (Machine Type Communication) but for critical MTC where robots or industrial devices are 5G wireless remotely controlled.

For example, as a method of transmitting radio waves in a frequency band of several hundred MHz to several tens of GHz or more as used in a fourth generation mobile communication system (4 G) or a fifth generation mobile communication system (5 G) in recent years, there is a method of partially removing a heat ray reflection film for coating a substrate by a method such as laser etching.

Among them, as a method of suitably transmitting a radio wave having a predetermined frequency or the like while maintaining the coating system function, it is known to remove the coating system so as to form a periodic pattern in which a portion in which the heat ray reflection film does not exist is composed of a plurality of lines, for example, so as to form a parallel line shape or a lattice shape forming a FSS in the form of grid lines arranged in a mesh-like manner.

In the case of removing the heat ray reflecting film by laser etching, generally, there is a limit on the size of a region that can be laser-processed in one process. For example, US-A-2013/0295300 describes a method in which a relatively wide region can be laser-processed relatively quickly in one process, but the size of the region that can be laser-processed in one process may still be insufficient for the size of the entire region to be processed. Therefore, when laser processing is performed on a region larger than a region that can be processed in one process, a pattern formed in a predetermined size that can be processed in one process is formed a plurality of times and continuously arranged. As a result, a continuous pattern can be formed in the entire desired region by connecting decoated tile-like portions like a so-called patchwork.

At this time, in order not to impair the radio wave transparency or the aesthetic appearance, it is ideal that a discontinuity or a deviation of a pattern does not occur at a joint between a plurality of patterns formed in mutually different processes. However, it is difficult to completely control the pattern forming position, and it is necessary to take into consideration that some error occurs in the pattern forming position at the time of laser processing. In particular, since the radio wave transparency is liable to be impaired when the pattern is interrupted, it is required to connect the patterns as reliably as possible in order to suppress this.

On the other hand, in the case of forming a lattice pattern, for example, by arranging a plurality of lattice patterns formed in mutually different processes so as to partially overlap each other, it is possible to suppress the interruption of the pattern that impairs the radio wave transparency. In EP2890655, it is described that the first grating surface is connected to the closed comb structure of the second grating surface via an open comb structure, thereby preventing a misalignment such as a double line or an uncoated region in the overlap region.

However, in the technique described, for example, when forming a parallel line pattern, it is difficult to suppress the discontinuity between a plurality of patterns formed in mutually different processes, and the degree of freedom of a pattern that can be selected is limited and on top of that, such this solution makes the connection between adjacent tiles visible because each connection point is aligned, and with the laser passing twice at that connection point gives an aligned over-visible effect. Thus, a user can see tiles due to these aligned connection point.

An object of one embodiment of the present invention is to provide a glazing unit capable of increasing the transmission of waves with a specific frequency such as with lower frequencies, below 6 GHz, and/or mmWave, above 15 GHz through the glazing unit while making the connection between adjacent tiles almost invisible to the eye.

### SUMMARY OF INVENTION

The present invention relates, in a first aspect, to a glazing unit comprising a glass sheet which is low in reflectance for RF radiation, a coating system which is high in reflectance for RF radiation disposed on the said glass sheet and at least one frequency selective decoated grid portion on the coating system. The said at least one frequency selective decoated portion comprises a first decoated grid and a second decoated grid. Each of the first decoated grid and the second decoated grid has decoated regions in the form of grid lines arranged in a mesh-like manner and the first decoated grid is connected to the second decoated grid at a connection area.

The solution as defined in the first aspect of the present invention is based on that at least at the connection area, the first decoated grid comprises a rake design with at least a missing tooth.

The solution as defined in the first aspect of the present invention is also based on that at least at the connection area, the second decoated grid comprises a rake design. Preferably, at least at the connection area, the rake design of the second decoated grid has at least a missing tooth.

The invention permits to connect at least a first decoated grid at the connection area with a rake design with at least a missing tooth to a second decoated grid with a rake design with at least a missing tooth by reducing the visibility of the connection between decoated grids

The present invention relates, in a second aspect, to a method for decoating a glazing unit comprising a glazing panel comprising a glass sheet (10) which is low in reflectance for RF radiation and a coating system (20) which is high in reflectance for RF radiation disposed on the said glass sheet, the method comprises a step B of decoating an at least one frequency selective decoated portion (30) on the coating system comprising following substeps:
B1. Decoating a first decoated grid having decoated regions in the form of grid lines arranged in a mesh-like manner,
B2. Decoating a second decoated grid having decoated regions in the form of grid lines arranged in a mesh-like manner.

The first decoated grid being connected to the second decoated grid at a connection area.

The solution as defined in the second aspect of the present invention is based on that at least at the connection area, the first decoated grid comprises a rake design with a least a missing tooth, and in that, at least at the connection area, the second decoated grid comprises a rake design. Preferably, at least at the connection area, the rake design of the second decoated grid has at least a missing tooth.

The present invention relates, in a third aspect, to an decoating apparatus to decoat a glazing unit comprising a glazing panel a glass sheet which is low in reflectance for RF radiation and a coating system which is high in reflectance for RF radiation disposed on the said glass sheet by the method according to the second aspect of the present invention.

It is noted that the invention relates to all possible combinations of features recited in the claims or in the described embodiments.

The following description relates to building applications but it's understood that the invention may be applicable to others fields like automotive or transportation applications such as train.

### BRIEF DESCRIPTION OF THE DRAWINGS

This and other aspects of the present invention will now be described in more detail, with reference to the appended drawings showing various exemplifying embodiments of the invention which are provided by way of illustration and not of limitation. The drawings are a schematic representation and not true to scale. The drawings do not restrict the invention in any way. More advantages will be explained with examples.

FIG. 1 is a schematic view of a glazing unit according to the first aspect of the invention.

FIG. 2 is a schematic view of a decoated grid according to the invention.

FIG. 3 is a schematic view of another decoated grid according to the invention.

FIG. 4 is a schematic view of a first decoated grid connected to the second decoated grid according to the invention.

FIG. 5 is a schematic view of a zoom at the connection area of a first decoated grid connected to the second decoated grid.

FIG. 6 is a schematic view of a frequency selective decoated grid portion comprising several decoated grids.

FIG. 7 is a schematic view of several decoated grids connected together.

FIG. 8 is a schematic view of the step B of the method according to the second aspect of the present invention.

FIG. 9 is a schematic view of an embodiment of the method according to the second aspect of the present invention.

FIG. 10 is a schematic view of another embodiment of the method according to the second aspect of the present invention.

### DETAILED DESCRIPTION

In this document to a specific embodiment and include various changes, equivalents, and/or replacements of a corresponding embodiment. The same reference numbers are used throughout the drawings to refer to the same or like parts.

As used herein, spatial or directional terms, such as “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. In the following description, unless otherwise specified, expression “substantially” mean to within 10%, preferably to within 5%.

Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Further, as used herein, the terms “deposited over” or “provided over” mean deposited or provided on but not necessarily in surface contact with. For example, a coating “deposited over” a substrate does not preclude the presence of one or more other coating films of the same or different composition located between the deposited coating and the substrate.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. In this document, “configured to (or set to)” may be interchangeably used in hardware and software with, for example, “appropriate to”, “having a capability to”, “changed to”, “made to”, “capable of”, or “designed to” according to a situation. In any situation, an expression “device configured to do” may mean that the device “can do” together with another device or component.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein. When it is described that a constituent element (e.g., a first constituent element) is “(functionally or communicatively) coupled to” or is “connected to” another constituent element (e.g., a second constituent element), it should be understood that the constituent element may be directly connected to the another constituent element or may be connected to the another constituent element through another constituent element (e.g., a third constituent element).

It is an object of the present invention to alleviate the above described problems an efficient and discrete frequency selective decoated grid portion on the coating system.

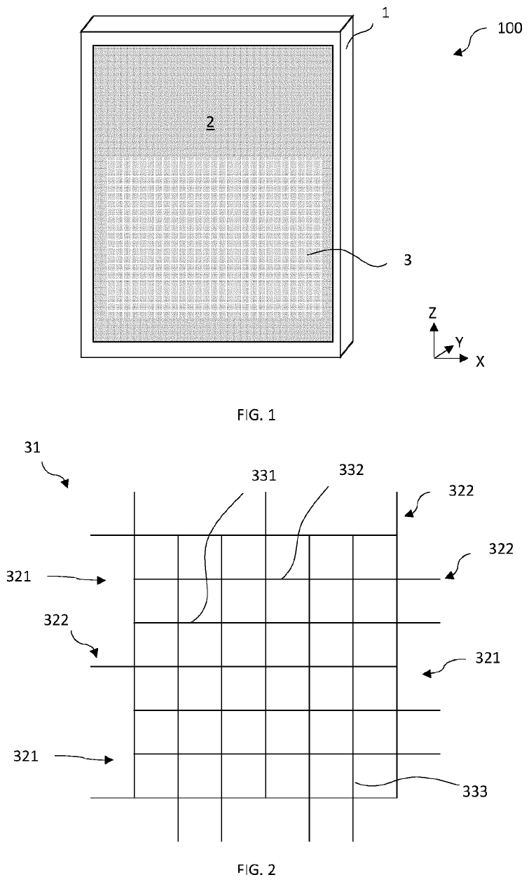

Especially, as illustrated in FIG. 1, the object of the first aspect of the present invention is a glazing unit 100.

### Glazing Unit

A glazing unit, according to the invention, can be used as a window, especially to close an opening of the stationary object, such as a building, or to close an opening of the mobile object, such a train, a boat, a car, . . .

In FIG. 1, the glazing unit has a height measured along the Z-axis, a width measured along the X-axis and a thickness measured along the Y-axis. The shape of the glazing panel in a plane view (X-Z plane) is not limited to a rectangle, and may be a circle or the like. In the present embodiment, the rectangle includes not only a rectangle or a square but also a shape obtained by chamfering corners of a rectangle or a square. The dimensions and/or the shape of the glazing unit depends on the desired application.

### Glass Sheet

According to the invention, the glazing unit 100 comprises a glazing panel comprising a glass sheet 1 which is low in reflectance for RF radiation.

Low in reflectance for RF radiation means that RF radiation are mostly transmitted through the material where high in reflectance for RF radiation means that RF radiation are mostly reflected on the surface of the material and/or absorbed by the material and the attenuation is at level of 20 decibels (dB) or more. Low in reflectance means an attenuation at level of 10 decibels (dB) or less.

The shape of the glazing panel in a plane view (X-Z plane) is not limited to a rectangle, and may be a circle or the like. In the present embodiment, the rectangle includes not only a rectangle or a square but also a shape obtained by chamfering corners of a rectangle or a square.

In some embodiments, the glass sheet 2 is at least transparent for visible waves in order to see-through and to let visible light passing through, meaning that the light transmission is greater than or equal to 1%.

In some embodiments, the glazing panel comprises at least two glass sheets separated by a spacer allowing to create a space filled by a gas like Argon to improve the thermal isolation of the glazing unit, creating an insulating glazing unit.

In some embodiments, the glazing panel comprises at least two glass sheets separated by spacers allowing to create a vacuum space to improve the thermal isolation of the glazing unit, creating a vacuum insulating glazing (VIG).

In some embodiments, the glazing panel can be a laminated glazing panel to reduce the noise and/or to ensure the penetration safety. The laminated glazing comprises glazing panels maintained by one or more interlayers positioned between glazing panels. The interlayers employed are typically polyvinyl butyral (PVB) or ethylene-vinyl acetate (EVA) for which the stiffness can be tuned. These interlayers keep the glazing panels bonded together even when broken in such a way that they prevent the glass from breaking up into large sharp pieces.

As the material of the glazing panel, for example, soda-lime silica glass, borosilicate glass, or aluminosilicate glass can be mentioned or other materials such as thermoplastic polymers, polycarbonates are known, especially for automotive applications, and references to glass throughout this application should not be regarded as limiting.

The glazing panel can be manufactured by a known manufacturing method such as a float method, a fusion method, a redraw method, a press molding method, or a pulling method. As a manufacturing method of the glazing panel 2, from the viewpoint of productivity and cost, it is preferable to use the float method.

The glass sheet can be flat or curved according to requirements by known methods such as hot or cold bending.

The glass sheet can be processed, i.e. annealed, tempered, . . . to respect with the specifications of security and anti-thief requirements.

The glass sheet can be a clear glass or a colored glass, tinted with a specific composition of the glass or by applying an additional coating or a plastic layer for example.

In case of several glass sheets, in some embodiments, each glass sheet can be independently processed and/or colored, . . . in order to improve the aesthetic, thermal insulation performances, safety, . . .

The thickness of the glazing panel is set according to requirements of applications.

The glazing panel can be formed in a rectangular shape in a plan view by using a known cutting method. As a method of cutting the glazing panel, for example, a method in which laser light is irradiated on the surface of the glazing panel to cut the irradiated region of the laser light on the surface of the glazing panel to cut the glazing panel, or a method in which a cutter wheel is mechanically cutting can be used. The glazing panel can have any shape in order to fit with the application, for example a windshield, a sidelite, a sunroof of an automotive, a lateral glazing of a train, a window of a building, . . .

In addition, the glazing unit can be assembled within a frame or be mounted in a double skin façade, in a carbody or any other means able to maintain a glazing unit. Some plastics elements can be fixed on the glazing panel to ensure the tightness to gas and/or liquid, to ensure the fixation of the glazing panel or to add external element to the glazing panel.

### Coating System

According to the invention, the glazing unit 100 comprises a coating system 2 which is high in reflectance for RF radiation. Said coating system 2 is disposed on the said glass sheet 1.

The coating system is high in reflectance and low in transmittance for RF radiation. Low in transmittance means a transmission with an attenuation at level of 20 decibels (dB) or more. It is understood that the glass sheet is low in reflectance, meaning an attenuation at level of 10 decibels (dB) or less.

According to the invention, the coating system 2 can be a functional coating in order to heat the surface of the glass sheet, to reduce the accumulation of heat in the interior of a building or vehicle or to keep the heat inside during cold periods for example. Although coating system are thin and mainly transparent to eyes in order to see-through and to let visible light passing through.

The coating system 2 can be made of layers of different materials and at least one of this layer is electrically conductive. The coating system is electrically conductive over the majority of one major surface of the glass sheet, in the X-Z plane.

The coating system 2 of the present invention has an emissivity of not more than 0.4, preferably less than 0.2, in particular less than 0.1, less than 0.05 or even less than 0.04. The coating system of the present invention may comprise a metal based low emissive coating system; these coatings typically are a system of thin layers comprising one or more, for example two, three or four, functional layers based on an infrared radiation reflecting material and at least two dielectric coatings, wherein each functional layer is surrounded by dielectric coatings. The coating system of the present invention may in particular have an emissivity of at least 0.010. The functional layers are generally layers of silver with a thickness of some nanometres, mostly about 5 to 20 nm. Concerning the dielectric layers, they are transparent and traditionally each dielectric layer is made from one or more layers of metal oxides and/or nitrides. These different layers are deposited, for example, by means of vacuum deposition techniques such as magnetic field-assisted cathodic sputtering, more commonly referred to as “magnetron sputtering”, or Chemical deposition such as CVD or PECVD or any other known deposition method. In addition to the dielectric layers, each functional layer may be protected by barrier layers or improved by deposition on a wetting layer.

In some embodiments, the coating system 2 is applied to the dielectric substrate 2, especially a glazing panel, to transform it to a low-E glazing unit. This metal-based coating system such as low-E or heatable coating systems.

In some embodiments, the coating system 2 can be a heatable coating applied on the dielectric substate, especially a glazing panel, to add a defrosting and/or a demisting function for example.

As the coating system, for example, a conductive film can be used. As the conductive film, for example, a laminated film obtained by sequentially laminating a transparent dielectric, a metal film, and a transparent dielectric, ITO, fluorine-added tin oxide (FTO), or the like can be used. As the metal film, for example, a film containing as a main component at least one selected from the group consisting of Ag, Au, Cu, and Al can be used.

Preferably, the coating system is placed on the majority of one surface of the glazing unit and more preferably on the whole usable surface of the glazing panel, in the X-Z plane.

In some embodiments, a masking element, such as an enamel layer, can be add on a part of the periphery of the glazing unit to hide the transition between a coated area and an non-coated area.

In some embodiments, the glazing unit can comprises several coating systems applied on same or different surface(s) of a glass sheet.

In some embodiments where the glazing panel comprises several glass sheets, different or same coating systems can be placed on different surfaces of the glass sheets.

### Frequency Selective Decoated Grid Portion

According to the invention, the glazing unit comprises at least one frequency selective decoated grid portion 3 on the coating system 2.

The at least one frequency selective decoated grid portion are situated within the coating system and form a communication window to let RF radiations passing thought the coating system and through the glazing unit depending on the grid parameters, such as distance between grid lines and shape of the grid mesh.

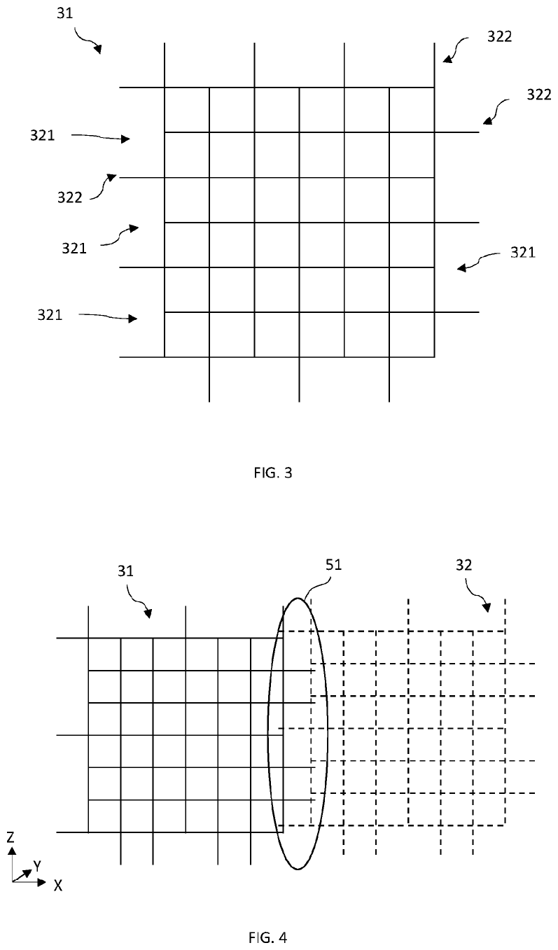

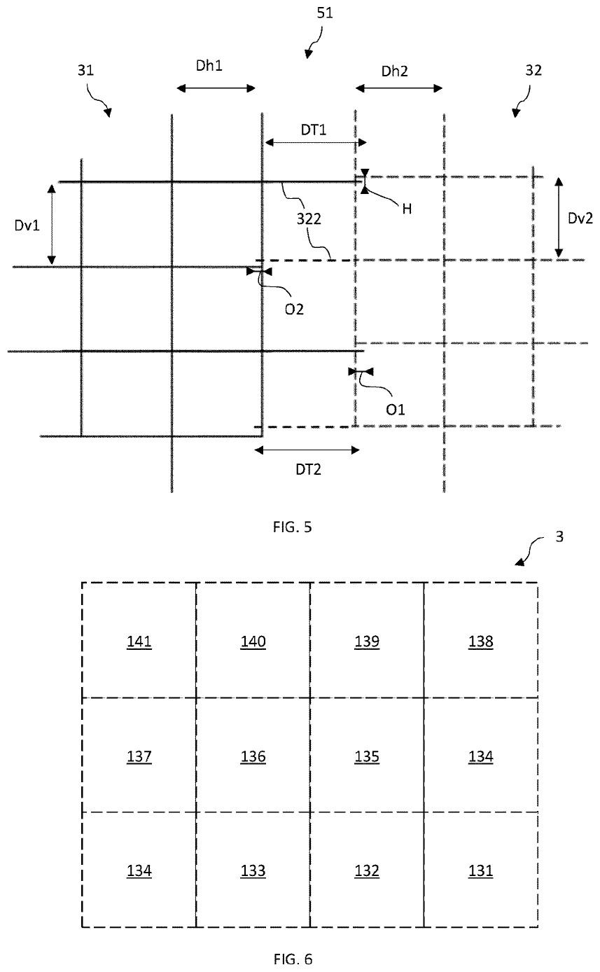

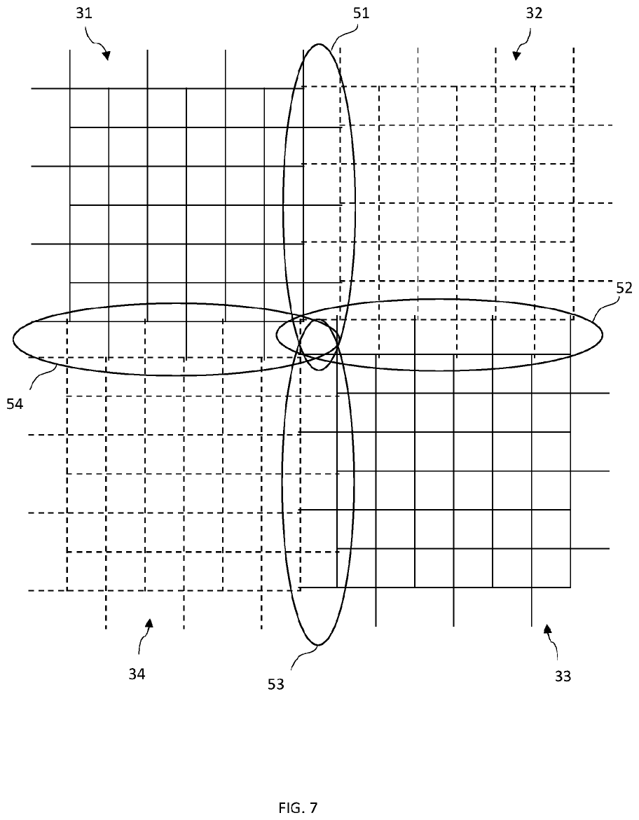

In the context of the invention, the term “decoated grid portion” includes a portion within the coating, which has, for example, linear decoating by a laser. The linear decoating forms a pattern with net meshes. In other words, the decoated grid is form by non-conductive or substantially non-conductive line segments marked in the coating system. Some of the non-conductive or substantially non-conductive line segments intersects with other non-conductive or substantially non-conductive line segments to form the decoated grid as illustrated in FIG. 1, FIG. 2, FIG. 3, FIG. 4, FIG. 5 and FIG. 7. Thus the decoated grid is formed by non-conductive or substantially non-conductive line segments and intersections between these non-conductive or substantially non-conductive line segments.

The linear decoating are visible in some incident angle due to the difference of colour between the decoating and the coating system.

The position of the at least one frequency selective decoated grid portion depends on the application.

### Decoated Grid

According to the present invention, the said at least one frequency selective decoated portion 3 comprises a first decoated grid 31 and a second decoated grid 32.

As illustrated in FIG. 2 to FIG. 7, a decoated grid has decoated regions, in black colour, in the form of grid lines arranged in a mesh-like manner, creating zones, in white colour, where the coating system is still present. This permits to maximize the untouched, meaning the surface in which the coating system has not been removed, surface of the coating system to keep properties of the coating system.

The grid meshes must have a distance between the lines that is significantly smaller than the wavelength of the desired electromagnetic radiation in question. To that end, the metal-containing coatings are, for example, removed in the form of lines using a suitable laser. Since only small amounts of the metal-containing coating have to be removed, the infrared radiation absorbing effect is largely retained.

Preferably, decoated segments can have a width between 15 μm and 150 μm, preferably between 30 μm and 70 μm, and more preferably substantially 50 μm.

As illustrated in FIG. 4 and FIG. 5, a first decoated grid 31 is connected to a second decoated grid 32 at a connection area 51, 52, 53, 54. It is understood that the first decoated grid and the second decoated grid are adjacent.

According to the invention, the term “connection area” corresponds to the area of connection between two adjacent decoated grids. Preferably, as illustrated in FIG. 4, a connection area 51 corresponds to an edge of a decoated grid, the first decoated grid 31, connected to the corresponding edge of the adjacent decoated grid, the second decoated grid 32.

According to the invention, at least at the connection area, decoated grids comprise a rake design in which on at least one side, the grid lines are not closed by surrounding grid lines and thus form a rake structure with teeth 322. It is understood that the rake design means an open structure oriented towards the exterior of the decoated grid. In the sense of the present invention, a rake design means a structure comprising teeth to form an open structure oriented towards the exterior of the decoated grid. To be an open structure the rake design comprises some teeth structure oriented towards the exterior of the decoated grid.

Preferably, a tooth 322 is a continuation of the grid line to optimize (minimizing) time of the decoating step.

In some embodiments, as illustrated in FIG. 2 and FIG. 3, the decoated grid can comprises a rake design on at least another side than on the connection side. In said figures, the decoated grid has a generic rectangular shape with then four edges. Each of the edges has a rake design to be able to be connected to another adjacent decoated grid to form a larger frequency selective decoated grid portion.

According to the invention, the rake design of the decoated grid has at least a missing tooth 321 meaning that, at least at the connection area, the first decoated grid comprises a rake design with at least a missing tooth 321 and the second decoated grid comprises a rake design. Preferably, at least at the connection area, the rake design of the second decoated grid has at least a missing tooth.

Preferably, along the edge of a decoated grid to be connected to another decoated grid, the rake design has a sequence of teeth and missing teeth. In some embodiments, the sequence can comprises several teeth separated by a missing teeth and/or several missing teeth separated by at least a tooth.

According to the invention, at the connection area, the connection between the first decoated grid and the second decoated grid is made via at least one tooth of the rake design of the first decoated grid and/or via at least one tooth of the rake design of the second decoated grid to facilitate the decoating process.

Preferably, to optimize the decoating process and to reduce the time of decoating a decoated grid, the grid lines form squares and/or rectangles.

In some embodiments, the squares are substantially 2×2 mm squares. In some other embodiments squares are substantially 4×4 mm squares. Dimensions of the squares depend of the desired EM frequency to let pass through the glazing unit.

Preferably, to optimize the decoating process and to reduce the time of decoating the frequency selective decoated grid portion, the decoated grid s that composed the patchwork to create the frequency selective decoated grid portion have same dimensions and grid lines forms same shape with same dimensions.

In some other embodiments, depending on the specific application, dimensions of each decoated grid or dimensions of the shape formed by the grid lines can be different.

In some preferred embodiments,, at the connection area, the rake design of the first decoated grid can match to the rake design of the second decoated grid forming a closed grid. That means that, at least at the connection area, the rake design of the first decoated grid is arranged to minimize teeth overlap and maximize grid pattern continuity and completion when engraved jointly with the second decoated grid. Overlap between corresponding edges is minimized by ensuring that for corresponding edges, rakes are complementary ie tooth from one rake does not overlap with the corresponding tooth of the other rake design and conversely.

As illustrated in FIG. 4, FIG. 5 and FIG. 6, along the edge of a decoated grid to be connected to another decoated grid, the sequence of the teeth and missing teeth of the rake design of the first decoated grid is matching with the sequence of the missing teeth and teeth of the rake design of the second decoated grid.

More preferably, in some embodiments according to the invention, at the connection area, the rake design of the first decoated grid can oppositely complementary match to the rake design of the second decoated grid forming together a complete closed grid meaning that a tooth exists in the rake design of the first decoated grid only where a tooth is missing at the corresponding connection of the rake design of the second decoated grid and that a missing tooth exists in the rake design of the first decoated grid only where a tooth exists at the corresponding connection of the rake design of the second decoated grid. In such embodiments, the decoated grid formed by the connection between at least the first decoated grid and the second decoated grid forms a complete and complementary closed grid. The term “complete” means that each of the zones formed by the mesh-like has the same dimensions and each of the edges is formed by a grid line of the first or the second decoated grid.

As illustrated in FIG. 4, FIG. 5 or FIG. 7, along the edge of a decoated grid to be connected to another decoated grid, the sequence of the teeth and missing teeth of the rake design of the first decoated grid is oppositely complementary matching with the sequence of the missing teeth and teeth of the rake design of the second decoated grid. In such embodiments, no tooth exists at the edge of the first decoated grid and second decoated grid when a tooth extends at the corresponding position respectively at the connected edge of the second decoated grid and first decoated grid.

In the embodiment of FIG. 5, the shown portion of the rake design of the first decoated grid 31 comprises two teeth 322 and has two missing teeth and the rake design of the second decoated grid 32 comprises two teeth 322 and has two missing teeth. Each tooth extends and connects the first decoated grid to the second decoated grid and no overlapping is present meaning that a tooth exists only in front of a missing tooth of the other decoated grid.

According to some embodiments, as illustrated in FIG. 5, the at least one tooth of the rake design of the first decoated grid touches the second decoated grid or has an overlap O1 relative to the second decoated grid, and/or the at least one tooth of the rake design of the second decoated grid touches the first decoated grid or has an overlap O2 relative to the first decoated grid.

The length DT1, DT2 of a tooth is from 50% to 150% of the length respectively Dh1 or Dv1, Dh2 or Dv2, depending the direction of the decoated line 331, 332, 333. Preferably, The length DT1, DT2 of a tooth for the connection is from 100% to 150%, that means the overlap O1, O2 is from 0% to 50% of the length respectively Dh1 or Dv1, Dh2 or Dv2.

In the term of the invention, a decoated grid connected to another decoated grid means that at least one decoated line 331, 332, 333, preferably a tooth is used for the connected of the decoated grid, interacts with the decoated lines of the other decoated grid.

In some embodiments, the overlap 01 is from 0 mm to 0.4 mm, preferably from 0 mm to 0.2 mm, and more preferably from 0 mm to 0.1 mm.

In some embodiments, the overlap O2 is from 0 mm to 0.4 mm, preferably from 0 mm to 0.2 mm, and more preferably from 0 mm to 0.1 mm.

The overlap O1, O2 can depend of the dimensions of the grid.

In some embodiments, due to the decoating process, adjacent decoated grids can be shift, mainly due to a misalignment and/or shifting of the decoating apparatus during the decoating steps, and a distance H can occur. It is understood that, preferably, the distance H is minimized and near 0 mm.

More preferably, to ensure a good RF transparency, the first decoated grid is connected to the second decoated grid by more than 50% of the teeth of the rake design of the first decoated grid, preferably the first decoated grid is connected to the second decoated grid by more than 80% of the teeth of the rake design of the first decoated grid and more preferably the first decoated grid is connected to the second decoated grid by more than 90% of the teeth of the rake design of the first decoated grid.

More preferably, to ensure a good RF transparency, wherein the first decoated grid is connected to the second decoated grid by more than 50% of the teeth of the rake design of the second decoated grid, preferably the first decoated grid is connected to the second decoated grid by more than 80% of the teeth of the rake design of the second decoated grid and more preferably the first decoated grid is connected to the second decoated grid by more than 90% of the teeth of the rake design of the second decoated grid.

Preferably, a majority of teeth of connected decoated grids are used for connection and even more preferably all teeth are used for the connection.

According to some embodiments, the at least one tooth of the rake design of the first decoated grid touches the second decoated grid or has an overlap O1 relative to the second decoated grid, and/or the at least one tooth of the rake design of the second decoated grid touches the first decoated grid or has an overlap O2 relative to the first decoated grid.

As illustrated in FIG. 5, a decoated grid can be connected to two or more adjacent decoated grids at a specific connection area 51, 52, 53, 54 to form a patchwork of decoated grids to increase the surface of the frequency selective decoated grid portion.

Coming back to FIG. 2 and FIG. 3, in some preferred embodiments, to facilitate the decoating steps while optimizing the time to decoat, a decoating grid has several substantially parallel edges two-by-two, preferably a rectangular or a square generic shape.

In such preferred embodiments, each of at least two parallel edges has a rake design with an oppositely complementary matching sequence of the teeth and missing teeth with the sequence of the teeth and missing teeth the other parallel edge. That means that along a decoated line 331, 332, 333 a teeth exists only on one edge, the other edge has a missing tooth.

More preferably, every parallel edges has a rake design with an oppositely complementary matching sequence of the teeth and missing teeth with the sequence of the teeth and missing teeth the other parallel edge. These particular embodiments allows to configure only one decoated grid reproduced as many time as necessary to form the frequency selective decoated grid portion. Each decoated grid is connected edge-to-edge to the adjacent decoated grid. Then, to facilitate the decoating process, decoated grids that composed the patchwork have the same shape meaning that the decoated lines, teeth and missing teeth are the same. These decoated grids are connected together two by two and thanks to the same shape these decoated grids are nested like a puzzle to form the frequency selective decoated grid portion while minimizing the vision of the connection points. In fact, each connection between two decoated lines is visible due to the fact that the coating is at least twice decoated at the same point and human eyes can see an over-illumination at these connection point.

It is understood that edges of decoated grids forming the border of the frequency selective decoated grid portion 3 can have no tooth to form a closed frequency selective decoated grid portion. That means that at the border of the frequency selective decoated grid portion, decoated grids can be different and without any tooth, because it is not a connection area, to minimize the possibility to see the decoating and to harmonize the frequency selective decoated grid portion.

With the present invention, this over-illumination is less visible even invisible to the eye because connection points are not aligned and then the eyes see only disparate points spread over a large area and cannot see a line, composed of aligned connection points, as this is the case with the prior art.

An embodiment, according to the second aspect of the invention, provides a method for decoating a glazing unit according to the first aspect of the invention.

As illustrated in FIG. 7, the method comprises a step B (800) of decoating an at least one frequency selective decoated portion (30) on the coating system. The step B comprises following substeps:
B1. Decoating (801) a first decoated grid having decoated regions in the form of grid lines arranged in a mesh-like manner, at least at the connection area, the first decoated grid comprises a rake design with a least a missing tooth
B2. Decoating (802) a second decoated grid having decoated regions in the form of grid lines arranged in a mesh-like manner, at least at the connection area, the second decoated grid comprises a rake design and the first decoated grid being connected to the second decoated grid at a connection area. Preferably, at least at the connection area, the rake design of the second decoated grid has at least a missing tooth.

To accelerate the decoating steps, especially for large frequency selective decoated grid portion, decoated grids are decoated by using a laser beam oriented with a galvo head. Then the laser head and/or the glazing unit moves to have the laser head in front of the next area to decoat.

Preferably, to optimize the time while limiting displacements, the patchwork of the frequency selective decoated grid portion is made by creating the decoated grids of the same row or column at once and then creating adjacent row or column and so on.

Depending on the dimension of the frequency selective decoated grid portion, the dimensions of the decoated grids be adapted, ie decoated grids of the last and/or the first row and/or of the last and/or the first column has a different size than the other decoated grids to respect the dimension of the frequency selective decoated grid portion to be less visible to eyes.

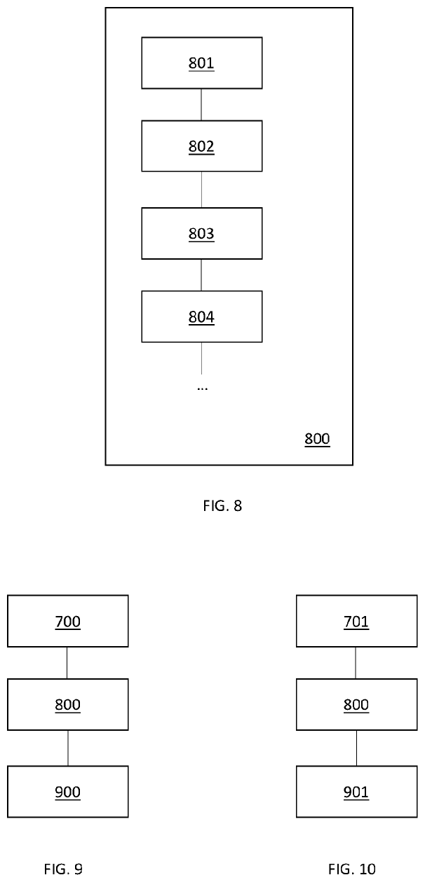

As illustrated in FIG. 8, the decoating steps can be executed in a factory. A step 700 to provide a glazing panel with a conveyor for example. The decoating step 800 is then performed in the factory to form a partially decoated glazing unit. This method can comprises a step 900 to mount the partially decoated glazing unit on a stationary object, for instance a building, or mounted on a mobile object, for instance a vehicle, a train.

As illustrated in FIG. 9, the decoating step can be performed in situ by using an decoating apparatus that can move. The term “in situ” means that the glazing unit is already mounted on a stationary object, for instance a building, or mounted on a mobile object, for instance a vehicle, a train. The decoating apparatus is moved (701) in front of the already mounted glazing unit. The decoating step 800 is performed in situ meaning that the glazing unit stay mounted during the decoating step. Then the decoating apparatus is moved (901) to another glazing unit or to be stored.

The method permits to create a larger frequency selective decoated portion in a fast manner. In fact, the decoated grids placed in a patchwork manner and connected edge-to-edge allow to create a larger frequency selective decoated portion especially when the decoated grids are created by a decoating apparatus using a galvo head to orientate the laser designed to decoat the coating system.

The present invention provides, in a third aspect, a decoating apparatus to decoat a glazing unit comprising a glazing panel a glass sheet which is low in reflectance for RF radiation and a coating system which is high in reflectance for RF radiation disposed on the said glass sheet by the method according to the second aspect of the present invention.

The decoating may be performed by laser ablation and the spacing of the slits, such as the decoating lines, is chosen to provide selectivity at the desired frequency. For that, the decoating apparatus comprises a laser head with a laser focused/to be focused on the coating system.

The decoating apparatus can be fixed on the glazing unit and/or around the glazing unit such as a frame surrounding the glazing unit, a car body, a wall or alike.

The decoating apparatus can stand in front of the glazing unit to decoat.

Such decoating apparatus are described in WO2015050762, WO2022112532, WO2021165064, WO2021165065, WO2021239603, WO2022079225, WO2022112530, WO2022112529, WO2022112521.

It is understood that any other apparatus that can decoat using the method according to the second aspect and/or providing a glazing unit according to the first aspect of the present invention can be used.

The present invention, with these different aspects, permits to obtain a glazing unit comprising at least one frequency selective decoated grid portion made of a patchwork of decoated grids less visible to eyes while optimizing the time of decoating it.

1. A glazing unit, comprising:
a glazing panel comprising a glass sheet which is low in reflectance for RF radiation,
a coating system which is high in reflectance for RF radiation disposed on the glass sheet,
at a frequency selective decoated grid portion on the coating system; the frequency selective decoated portion comprising a first decoated grid and a second decoated grid each of the first decoated grid and the second decoated grid having decoated regions in a form of grid lines arranged in a mesh-like manner; the first decoated grid being connected to the second decoated grid at a first connection area,
wherein, at least at the first connection area, the first decoated grid comprises a rake design with at least a missing tooth, wherein, at least at the first connection area, the second decoated grid comprises a rake design.

2. The glazing unit according to claim 1, wherein at least at the first connection area, the rake design of the second decoated grid has at least a missing tooth.

3. The glazing unit according to claim 1, wherein, at the first connection area, a connection between the first decoated grid and the second decoated grid is made via a tooth of the rake design of the first decoated grid and/or via a tooth of the rake design of the second decoated grid and wherein the tooth of the rake design of the first decoated grid touches the second decoated grid or has an overlap O1 relative to the second decoated grid, and/or the tooth of the rake design of the second decoated grid touches the first decoated grid or has an overlap O2 relative to the first decoated grid.

4. The glazing unit according to claim 3, wherein the overlap O1 is from 0 mm to 0.4 mm.

5. The glazing unit according to claim 3, wherein the overlap O2 is from 0 mm to 0.4 mm.

6. The glazing unit according to claim 1, wherein the grid lines form squares and/or rectangles.

7. The glazing unit according to claim 1, wherein, at the first connection area, the rake design of the first decoated grid is matched to the rake design of the second decoated grid forming a closed grid.

8. The glazing unit according to claim 1, wherein, at the first connection area, the rake design of the first decoated grid is oppositely complementary matched to the rake design of the second decoated grid forming together a complete closed grid.

9. The glazing unit according to claim 1, wherein the first decoated grid is connected to the second decoated grid by more than 50% of the teeth of the rake design of the first decoated grid.

10. The glazing unit according to claim 1, wherein the first decoated grid is connected to the second decoated grid by more than 50% of the teeth of the rake design of the second decoated grid.

11. The glazing unit according to claim 1, wherein the frequency selective decoated portion further comprises a third decoated grid having decoated regions in a form of grid lines arranged in a mesh-like manner; wherein the third decoated grid is connected to the first decoated grid at a second connection area and wherein at least at the second connection area, the third decoated grid comprises a rake design with at least a missing tooth.

12. The glazing unit according to claim 11, wherein the frequency selective decoated portion further comprises a fourth decoated grid having decoated regions in the form of grid lines arranged in a mesh-like manner; wherein the fourth decoated grid is connected to the second decoated grid at a third connection area; at least at the third connection area, the third decoated grid comprises a rake design with at least a missing tooth, wherein the fourth decoated grid is connected to the third decoated grid at a fourth connection area; at least at the fourth connection area, the fourth decoated grid comprises a rake design with at least a missing tooth.

13. A method for decoating a glazing unit comprising a glazing panel having a glass sheet which is low in reflectance for RF radiation and a coating system which is high in reflectance for RF radiation disposed on the glass sheet, the method comprising:
decoating a frequency selective decoated portion on the coating system, the decoating further comprising:
Decoating a first decoated grid having decoated regions in a form of grid lines arranged in a mesh-like manner,
Decoating a second decoated grid having decoated regions in the form of grid lines arranged in a mesh-like manner;
the first decoated grid being connected to the second decoated grid at a connection area,
wherein, at least at the connection area, the first decoated grid comprises a rake design with a least a missing tooth,
and in that, at least at the connection area, the second decoated grid comprises a rake design.

14. A decoating apparatus to decoat a glazing unit comprising a glazing panel a glass sheet which is low in reflectance for RF radiation and a coating system which is high in reflectance for RF radiation disposed on the said glass sheet by the method according to claim 13.

15. The glazing unit according to claim 3, wherein the overlap O1 is from 0 mm to 0.1 mm.

16. The glazing unit according to claim 3, wherein the overlap O2 is from 0 mm to 0.1 mm.

17. The glazing unit according to claim 1, wherein the first decoated grid is connected to the second decoated grid by more than 80% of the teeth of the rake design of the first decoated grid.

18. The glazing unit according to claim 1, wherein the first decoated grid is connected to the second decoated grid by more than 90% of the teeth of the rake design of the second decoated grid.
